(19) United States
(12) Patent Application Publication
(10) Pub. No.: US 2026/0032220 A1
(43) Pub. Date: Jan. 29, 2026

(54) PROJECTOR

(71) Applicant: SEIKO EPSON CORPORATION, Tokyo (JP)

(72) Inventors: Takuo YONEYAMA, AZUMINO-SHI (JP); Kazuhisa MIZUSAKO, SHIOJIRI-SHI (JP)

(21) Appl. No.: 19/282,076

(22) Filed: Jul. 28, 2025

(30) Foreign Application Priority Data
Jul. 29, 2024 (JP) 2024-122178

(51) Int. Cl. H04N 9/31

(52) U.S. Cl. CPC H04N 9/3155; H04N 9/3108; H04N 9/3129; H04N 9/317

(57) ABSTRACT

A projector according to the present disclosure includes a light source device that cyclically emits a first light, a light scanning device that cyclically scans the first light, a light modulation device that modulates the first light emitted from the light scanning device, and a projection optical system that projects an image light emitted from the light modulation device. The light modulation device includes a liquid crystal element that converts the first light into the image light. A modulation period in which the first light is modulated in a liquid crystal layer of the liquid crystal element includes a first period from a time when an electrical signal is input to a time when an amount of modulation changes to a predetermined value, and a second period in which a refractive index is held. The first light is incident on the light modulation device in the second period.

The present application is based on, and claims priority from JP Application Serial Number 2024-122178, filed Jul. 29, 2024, the disclosure of which is hereby incorporated by reference herein in its entirety.

### BACKGROUND

### 1. Technical Field

The present disclosure relates to a projector.

### 2. Related Art

As a projector such an image display apparatus, there has been proposed an apparatus that temporally scans illumination light emitted from a light source device on a modulation surface of a light modulation device such as a liquid crystal panel to illuminate the light modulation device with color light and projects image light emitted from the light modulation device onto a projection surface such as a screen by a projection optical system.

For example, JP-A-2004-325576 discloses a projector including a light source 1 amp that emits illumination light, a liquid crystal display element, a fly-eye lens that irradiates part of pixels of the liquid crystal display element with the illumination light, a superimposing lens, a parallelizing lens, and a rotating prism that scans the illumination light to illuminate the liquid crystal display element. JP-A-2004-325576 discloses that the illumination light is scanned in synchronization with a cycle in which information for the rotating prism to modulate the illumination light is input to the pixels of the liquid crystal display element.

JP-A-2004-325576 is an example of the related art.

In the projector disclosed in JP-A-2004-325576 described above, there is a possibility that the illuminance of one or more color lights increase or decrease beyond an assumed value in a period from the rising start time to the rising completion time of the liquid crystal on the modulation surface of the liquid crystal display element and a period from the falling start time to the falling completion time of the liquid crystal, and illuminance unevenness may occur in an image projected on the projection surface such as a screen. Therefore, a measure for suppressing the occurrence of illuminance unevenness in a projected image is desired.

### SUMMARY

A projector according to an aspect of the present disclosure includes a light source device that cyclically emits a first light, a light scanning device that cyclically scans the first light emitted from the light source device, a light modulation device that modulates the first light emitted from the light scanning device according to image information, and a projection optical system that projects an image light emitted from the light modulation device. The light source device includes a first light emitting element that emits the first light. The light scanning device includes a transmissive optical element having an incident surface on which the first light emitted from the light source device is incident and an emission surface from which the first light incident from the incident surface is emitted. The light modulation device includes a liquid crystal element that forms an image by converting the first light emitted along a first direction according to the input image information into an image light. A direction in which the light scanning device scans the first light is the first direction. The light scanning device scans the first light in synchronization with a drive cycle of the light source device and an image formation cycle of the light modulation device. The liquid crystal element includes a liquid crystal layer in which an amount of modulation for the first light changes according to an input electrical signal. A modulation period in which the first light is modulated in the liquid crystal layer includes a first period from a time when an electrical signal is input to a time when an amount of modulation reaches a predetermined value and a second period in which a refractive index is held at a predetermined value. The first light emitted from the light source device is incident on the light modulation device in the second period.

### BRIEF DESCRIPTION OF THE DRAWINGS

FIG. 1 is a schematic diagram of a projector according to a first embodiment.

FIG. 2 is a schematic diagram showing a behavior of a light scanning device of the projector in FIG. 1.

FIG. 3 is a schematic diagram showing the behavior of the light scanning device of the projector in FIG. 1.

FIG. 4 is a schematic diagram showing the behavior of the light scanning device of the projector in FIG. 1.

FIG. 5 is a time chart relating to operation of a light source of a light source device and a liquid crystal panel of a light modulation device of the projector in FIG. 1.

FIG. 6 is a schematic diagram showing the timing of color lights emitted from the respective units of the projector in FIG. 4.

FIG. 7 is a schematic diagram showing distribution examples of the respective color regions in a modulation surface of a light modulation device and a projection image in the projector in FIG. 1.

FIG. 8 is another schematic diagram showing the timing of the color lights emitted from the respective units of the projector in FIG. 4.

FIG. 9 is another schematic diagram showing distribution examples of the respective color regions in modulation surfaces of light modulation devices and a projection image in the projector in FIG. 1.

FIG. 10 is a flowchart relating to control performed by a control section of the projector in FIG. 1.

FIG. 11 is another schematic diagram showing the timing of the color lights emitted from the respective units of the projector in the related art.

FIG. 12 is another schematic diagram showing distribution examples of the respective color regions in modulation surfaces of light modulation devices and a projection image in a projector of related art.

FIG. 13 is a schematic diagram of a projector according to a second embodiment.

### DESCRIPTION OF EMBODIMENTS

In the following respective drawings, dimensional scales of the component elements may be varied for clarity of the respective component elements.

### First Embodiment

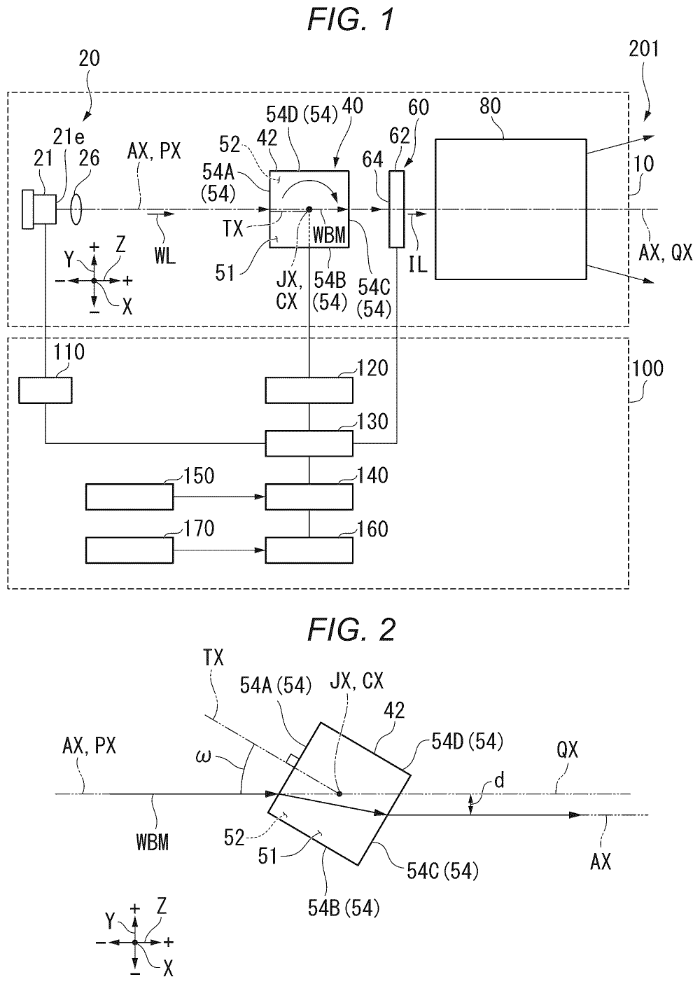

A first embodiment of the present disclosure will first be described with reference to FIGS. 1 to 10.

First, the basic configuration of a projector 201 according to the first embodiment of the present disclosure will be described. FIG. 1 is a schematic diagram of the projector 201. The projector 201 is a single-LCD image display apparatus including one liquid crystal panel as a light modulation device. As shown in FIG. 1, the projector 201 includes a light source device 20, a light scanning device 40, a light modulation device 60, a projection optical system 80, a light source output control device 110, a rotation control device 120, a drive control device 130, a central processing unit 140, a user interface 150, a video processing circuit 160, and a video interface 170.

The light source device 20 includes a light emitting element 21 that emits a white light WL and a parallelizing lens 26. The light emitting element 21 corresponds to a first light emitting element described in What is claimed is. The white light WL corresponds to a first light, which will be described later, and includes a red light, a green light, and a blue light. In the following description, an axis parallel to an optical axis AX and the principal ray of the white light WL emitted from the light emitting element 21 is defined as a Z axis, one side in the direction parallel to the Z axis is defined as a −Z side, and the other side in the direction parallel to the Z axis is defined as a +Z side. One axis orthogonal to the Z axis is defined as an X axis, one side in the direction parallel to the X axis is defined as a −X side, and the other side in the direction parallel to the X axis is defined as a +X side. An axis orthogonal to the Z axis and the X axis is defined as a Y axis, one side in the direction parallel to the Y axis is defined as a −Y side, and the other side in the direction parallel to the Y axis is defined as a +Y side.

The light emitting element 21 emits the white light WL from an emission surface 21e toward the +Z side along the Z axis. The light emitting element 21 is, for example, a white laser diode (LD) or a white light emitting diode (LED).

The parallelizing lens 26 is disposed in the optical path of the white light WL emitted from the light emitting element 21 at the +Z side of the emission surface 21e of the light emitting element 21. The center axis of the parallelizing lens 26 overlaps the optical axis AX.

The parallelizing lens 26 emits the white light WL emitted from the light emitting element 21 along the optical axis AX as a parallel light parallel to the Z axis. The parallelizing lens 26 is, for example, a biconvex lens. The parallelizing lens 26 may be a plano-convex lens having a flat incident surface parallel to the XY plane containing the X axis and the Y axis and an emission surface convex toward the +Z side. Although the parallelizing lens 26 is disposed apart from the emission surface 21e of the light emitting element 21 in FIG. 1, when the parallelizing lens 26 is a plano-convex lens, the parallelizing lens 26 may be in contact with the emission surface 21e of the light emitting element 21.

The light scanning device 40 is disposed in the optical path of the white light WL emitted from the parallelizing lens 26 of the light source device 20 at the +Z side of the parallelizing lens 26. The light scanning device 40 scans the white light WL emitted from the light source device 20 in the XY plane.

The light scanning device 40 includes a light-transmissive member 42 and a rotating device such as a motor (not illustrated). The light-transmissive member 42 corresponds to a transmissive optical element, which will be described later. The light-transmissive member 42 is disposed in the optical path of the white light WL emitted from the parallelizing lens 26 of the light source device 20 at the +Z side of the parallelizing lens 26. The light-transmissive member 42 is formed in a columnar shape. A center axis JX of the light-transmissive member 42 is parallel to the X axis and intersects the optical axis AX or passes near the optical axis AX. The light-transmissive member 42 is a polygonal prism having the center axis JX.

The light-transmissive member 42 has two end surfaces 51, 52 intersecting the center axis JX and parallel to the YZ plane containing the Y axis and the Z axis, and a plurality of side surfaces 54. The end surfaces 51, 52 correspond to a first surface, which will be described later, and is disposed relatively at the +X side. The plurality of side surfaces 54 correspond to incident surfaces, emission surfaces, and second surfaces, which will be described later, are disposed at the −X side of the end surface 51, and overlap the end surface 51 as seen along the X axis. The end surfaces 51, 52 have polygonal shapes centered on the center axis JX.

The number of side surfaces 54 is the same as the number of corners and the number of sides of the end surfaces 51, 52. The side surfaces 54 couple the respective outer peripheral end sides of the plurality of outer peripheral end sides of the end surface 51 and the outer peripheral end sides of the end surface 52 overlapping the respective outer peripheral end sides as seen along the X axis.

The end surfaces 51, 52 have, for example, regular quadrangular shapes, and have the same shape, size, and area as each other. The light-transmissive member 42 has the two end surfaces 51, 52 and the four side surfaces 54A, 54B, 54C, and 54D. The side surfaces 54A, 54B, 54C, and 54D have the same size and area as one another. The sizes and areas of the side surfaces 54A, 54B, 54C, and 54D are appropriately larger than an irradiation area centered on the optical axis AX of the white light WL emitted from the parallelizing lens 26 of the light source device 20 according to a scanning region of the white light WL as will be described later.

As seen along the X axis, the side surfaces 54A and 54C face each other with the center axis JX in between and are parallel to each other. The side surfaces 54B and 54D face each other with the center axis JX in between and are parallel to each other. In this specification, the two side surfaces 54 being parallel to each other means that the angle formed by the two side surfaces is in a range from 0° to 5° in consideration of the processing accuracy of the material of the light-transmissive member 42, the allowable range of the parallelism of the white light WL, and the like.

The light-transmissive member 42 is disposed to be rotatable around the center axis JX. The center axis JX corresponds to a rotation axis CX of the light-transmissive member 42. The light-transmissive member 42 transmits the white light WL incident from the −Z side along the Z axis and the optical axis AX while rotating around the rotation axis CX, and emits the white light WL toward the +Z side.

In the specification, a state in which the light-transmissive member 42 is rotating around the rotation axis CX may be referred to as a rotating state. In the rotating state of the light-transmissive member 42, the side surface 54 on which the white light WL emitted from the parallelizing lens 26 of the light source device 20 is incident is not fixed to one of the four side surfaces 54A, 54B, 54C, and 54D, but corresponds to any one or two side surfaces 54 of the four side surfaces 54A, 54B, 54C, and 54D, and changes over time.

The number of the side surfaces 54 in the light-transmissive member 42 is not limited to four, and is preferably 2×m. m is a natural number of 2 or more. When the number of the side surfaces 54 is an even number of four or more, all the side surfaces 54 are parallel to the facing side surfaces 54, the generation of the stray light of the white light WL transmitted through the light-transmissive member 42 is suppressed, and the light use efficiency in the projector 201 is improved.

The material of the light-transmissive member 42 is a material having light transmissivity for the white light WL, and is, for example, one of optical glass such as BK7 as borosilicate crown glass or B270 as high transparency crown glass, quartz, transparent resin, and the like.

The light modulation device 60 is disposed in the optical path of the white light WL emitted from the light-transmissive member 42 of the light scanning device 40 in the region scanned by the white light WL at the +Z side of the light-transmissive member 42. The light modulation device 60 has a modulation surface 64 parallel to the XY plane. The position, the size, the area, and the shape of the modulation surface 64 on the XY plane are equivalent to those of the region that can be scanned with the white light WL by the light-transmissive member 42 and irradiated with the white light WL, and are equivalent to those of a range in which an appropriate margin region is secured outside the irradiated region with the white light WL described above on the XY plane.

The light modulation device 60 modulates the white light WL incident from the −Z side by the light scanning device 40 with an electrical signal input from the drive control device 130 in accordance with image information to be projected as will be described later, and converts the light into an image light IL. The light modulation device 60 is, for example, a transmissive liquid crystal panel 62. The liquid crystal panel 62 corresponds to a liquid crystal element, which will be described later. The liquid crystal panel 62 forming the light modulation device 60 has a plurality of pixels two-dimensionally arranged along the X axis and the Y axis in the XY plane. The plurality of pixels of the liquid crystal panel 62 form the modulation surface 64.

The plurality of pixels of the liquid crystal panel 62 include switching elements. The switching element is, for example, a polysilicon thin film transistor (TFT). The white light WL incident on the plurality of pixels of the liquid crystal panel 62 includes a red light, a green light, and a blue light constituting three primary colors of light. To the switching element of each pixel, an electrical signal corresponding to the intensity and the amount of each of the red light, the green light, and the blue light at the relative position of each pixel on the modulation surface 64 of the light modulation device 60 in the image to be projected by the projector 201 is supplied from the drive control device 130.

Each pixel of the liquid crystal panel 62 modulates the vibration direction of each of the red light, the green light, and the blue light contained in the white light WL by the operation of the switching element according to the electrical signal described above, generates a red image light, a green image light, and a blue image light, and emits the image light IL according to the amount ratio of lights of the three colors. The light modulation device 60 outputs the image light IL generated by the liquid crystal panel 62 toward the +Z side along the optical axis AX and the Z axis.

Each pixel of the liquid crystal panel 62 has red, green, and blue color filters (not shown). Accordingly, the light modulation device 60 outputs a full-color image light IL that can be generated by the red image light, the green image light, and the blue image light. The projector 201 can perform full-color display.

Note that each pixel of the liquid crystal panel 62 does not necessarily have a color filter. In that case, when one of the color lights of the red light, the green light, and the blue light is emitted from the light emitting element 21 of the light source device 20, the light modulation device 60 emits a monochromatic image light IL corresponding to the one of the color lights described above. When each pixel of the liquid crystal panel 62 does not have a color filter, the projector 201 can perform monochromatic display.

The driving method of the liquid crystal panel 62 is not particularly limited, but is, for example, a twisted nematic (TN) method, a vertical alignment (VA) method, or an in plane switching (IPS) method.

The projection optical system 80 is disposed in the optical path of the image light IL emitted from the liquid crystal panel 62 of the light modulation device 60 at the +Z side of the liquid crystal panel 62. The projection optical system 80 enlarges and projects the image light IL generated by the light modulation device 60 toward a projection surface such as a screen. The projection optical system 80 includes a plurality of optical lenses disposed along the Z axis. Examples of the optical lens include a plano-convex lens, a plano-concave lens, a biconvex lens, a meniscus lens, an aspherical lens, and a freeform surface lens.

A light exiting-side polarizer (not shown) may be disposed in the optical path of the image light IL between the light modulation device 60 and the projection optical system 80. The light exiting-side polarizer transmits a specific linearly-polarized light of the image light IL emitted from the light modulation device 60 and absorbs or reflects a polarization component other than the specific linearly-polarized light. When an absorption-type polarizer is used as the light exiting-side polarizer, the return light from the light exiting-side polarizer toward the −Z side is reduced, the generation of stray light in the projector 201 is suppressed, and the light use efficiency is improved.

The light source device 20, the light scanning device 40, the light modulation device 60, and the projection optical system 80 described above form an optical unit 10 of the projector 201.

The light source output control device 110 is electrically coupled to the light emitting element 21 of the light source device 20 in a wired or wireless manner, and controls the amount of the white light WL emitted from the light emitting element 21. Specifically, the light source output control device 110 outputs an electrical signal related to a drive voltage or a drive current for controlling the amount of the white light WL emitted from the light emitting element 21 to the light emitting element 21, and causes the light emitting element 21 to cyclically emit the white light WL. The light source output control device 110 is, for example, an LD driver or an LED driver. The driver as the light source output control device 110 stores and saves a program of a cyclic drive voltage value or drive current value for the light emitting element 21 corresponding to the elapsed time and the time t. The drive voltage value or the drive current value for the light emitting element 21 corresponding to the elapsed time and the time t will be described later.

The rotation control device 120 is electrically coupled to the light-transmissive member 42 of the light scanning device 40 via a motor in a wired or wireless manner, and controls the rotation speed of the light-transmissive member 42 around the rotation axis CX. The rotation control device 120 includes, for example, a motor driver.

The drive control device 130 is electrically coupled to the light source output control device 110 and the rotation control device 120, and is electrically coupled to the liquid crystal panel 62 of the light modulation device 60 in a wired or wireless manner. The drive control device 130 outputs an electrical signal to each of the light source output control device 110 and the rotation control device 120, and controls the position, the region, and the timing on the XY plane at which the white light WL emitted from the light emitting element 21 of the light source device 20 is scanned by the light-transmissive member 42 of the light scanning device 40 and irradiated on the modulation surface 64 of the liquid crystal panel 62 of the light modulation device 60. The drive control device 130 supplies an electrical signal to each pixel of the liquid crystal panel 62 on the modulation surface 64 in accordance with the irradiation position, the irradiated region, and the timing of the white light WL described above.

The drive control device 130 drives the pixels corresponding to the three primary colors of the light emitting element 21 of the light source device 20, the light-transmissive member 42 of the light scanning device 40, and the liquid crystal panel 62 of the light modulation device 60 in synchronization with one another based on the refresh rate of the liquid crystal panel 62. When a synchronization deviation is generated among the configurations described above, the deviation may be feedback-corrected by a method of detecting the amount of the image light IL at regular intervals or the like. The image information output to the liquid crystal panel 62 may be appropriately subjected to processing such as image processing and frame interpolation. The white light WL emitted from the light emitting element 21 may be subjected to area dimming based on the scanning position by the light-transmissive member 42 and the image information output to the video panel 62.

The drive control device 130 is, for example, a processor. The processor as the drive control device 130 stores and saves the timing of supplying the drive voltage value or the drive current value to the light emitting element 21, the timing of increasing or decreasing the rotation speed of the light-transmissive member 42, the timing of supplying the drive voltage of the amount of modulation of the color light suitable for each pixel of the liquid crystal panel 62, and the like.

The central processing unit (CPU) 140 is electrically coupled to the drive control device 130 in a wired or wireless manner. The central processing unit 140 transmits video information and drive information to the drive control device 130. The central processing unit 140 receives frame information from the video processing circuit 160, and receives information such as a refresh rate of the liquid crystal panel 62 from a user interface (UI) 150. The refresh rate of the liquid crystal panel 62 is optionally set by a user of the projector 201 from options provided in advance, and is, for example, 60 Hz or 90 Hz.

The user interface 150 is electrically coupled to the central processing unit 140 in a wired or wireless manner. The user interface 150 transmits information such as a refresh rate to the central processing unit 140. The user interface 150 is, for example, an input device provided in the projector 201 or a tablet terminal device.

The video processing circuit 160 is electrically coupled to the central processing unit 140 in a wired or wireless manner. The video processing circuit 160 receives the video information n from the video interface 170, decomposes the received video information into pieces of frame information of respective colors, and transmits the pieces of frame information of the respective colors of the video and the image to the central processing unit 140. The video processing circuit 160 includes, for example, a VRAM (Video Random Access Memory) as a memory dedicated to video processing.

The video interface 170 is electrically coupled to the video processing circuit 160 in a wired or wireless manner. The video interface 170 transmits image information and video information to be projected by the projector 201 to the video processing circuit 160.

The light source output control device 110, the rotation control device 120, the drive control device 130, the central processing unit 140, the user interface 150, the video processing circuit 160, and the video interface 170 described above form the control section 100 of the projector 201.

Next, scanning of the white light WL by the light scanning device 40 of the projector 201 will be described. As seen from the +X side, that is, from the front side of the paper surface of FIG. 1 toward the −X side, that is, toward the back side of the paper surface of FIG. 1, the light-transmissive member 42 of the light scanning device 40 rotates clockwise around the rotation axis CX, for example, as indicated by an arrow.

FIG. 1 illustrates a first state, that is, an initial state in a rotation state of the light-transmissive member 42 of the light scanning device 40. In the first state, the side surface 54A of the light-transmissive member 42 is located closest to the −Z side among the four side surfaces 54 and is parallel to the XY plane. An angle formed counterclockwise from a virtual line TX passing through the center axis JX and the rotation axis CX and orthogonal to the side surface 54A to an axis PX extending parallel to the Z axis and to the −Z side with the center axis JX and the rotation axis CX as a start point is defined as a rotation angle ω. The actual white light WL has predetermined luminous flux widths on the X axis, the Y axis, and the XY plane. In the description of the scanning and the behavior of the white light WL, a beam WBM on the optical axis AX of the white light WL is focused.

As shown in FIG. 1, in the first state, the rotation angle ω is 0°, and the white light WL incident on the light-transmissive member 42 from the −Z side is perpendicular to the side surface 54A and thus, not refracted at the side surface 54A. The white light WL travels parallel to the Z axis, is incident perpendicularly to the side surface 54C, is not refracted at the side surface 54C, and is emitted from the side surface 54C toward the +Z side along the Z axis. The beam WBM of the white light WL passes through the center of the side surface 54A in the XY plane, the center axis JX and the rotation axis CX, and the center of the side surface 54C in the XY plane. A separation distance d on the Z axis between the beam WBM emitted from the side surface 54C of the light-transmissive member 42 and an axis QX extending parallel to the Z axis toward the +Z side with the center axis JX and the rotation axis CX as a start point is substantially zero.

FIG. 2 is a schematic diagram of a second state in which the rotation of the light-transmissive member 42 proceeds from the first state. As shown in FIG. 2, in the second state, the rotation angle ω is larger than 0° and smaller than 45°. In the second state, since the white light WL incident on the light-transmissive member 42 from the −Z side is incident on the side surface 54A at an incident angle equivalent to a narrow angle formed by a perpendicular line of the side surface 54A and the beam WBM, the white light is refracted to the −Y side with respect to the center axis JX at the side surface 54A according to the incident angle to the side surface 54A, the refractive index n of the material of the light-transmissive member 42, and the Snell's law.

In the second state, as described above, the white light WL incident on the inside of the light-transmissive member 42 is refracted at the side surface 54A, is incident on the side surface 54C at the incident angle determined by the incident angle of the white light WL on the side surface 54A, the refractive index n, and the Snell's law, is refracted at the side surface 54C, and is emitted from the side surface 54C toward the +Z side along the Z axis. The separation distance d in the second state is larger than the separation distance d in the first state.

Regardless of the state of the rotation of the light-transmissive member 42, the incident angle at which the white light WL enters one or two side surfaces 54 of the four side surfaces 54A, 54B, 54C, and 54D of the light-transmissive member 42 and the white light WL enters one or two side surfaces 54 is determined in accordance with the rotation angle ω. The separation distance d is determined by the incident angle of the white light WL on one or two side surfaces 54 according to the rotation angle ω, the refractive index n, and the distances on the Z axis between the side surfaces 54A and 54C and between the side surfaces 54B and 54D, that is, the lengths of one side of the polygons of the end surfaces 51, 52.

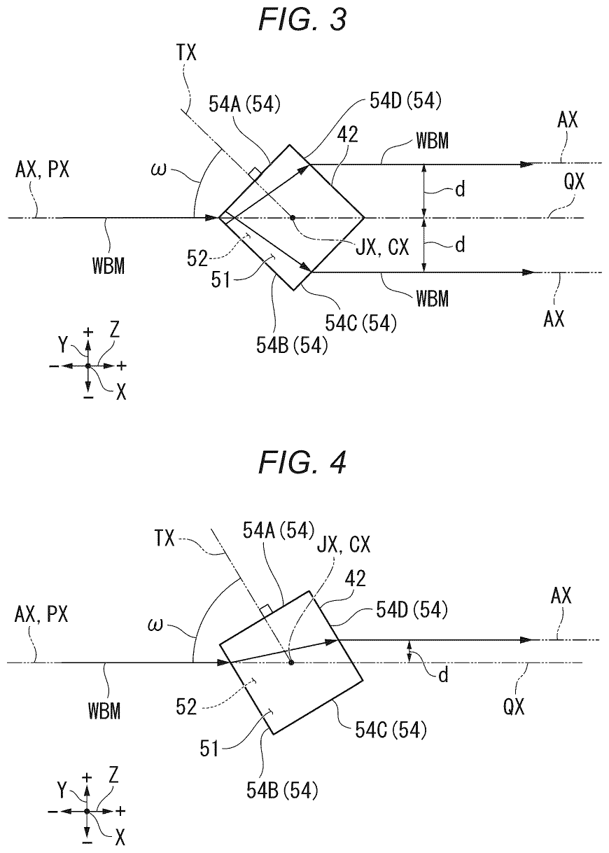

FIG. 3 is a schematic diagram of a third state in which the rotation of the light-transmissive member 42 further proceeds from the second state. As shown in FIG. 3, the rotation angle ω is 45°, and the beam WBM of the white light WL incident on the light-transmissive member 42 from the −Z side is incident on the angle between the side surfaces 54A and 54B. In the third state, of the white light WL incident on the light-transmissive member 42 from the −Z side, the white light WL at the +Y side of the angle between the side surfaces 54A and 54B is refracted at the side surface 54A, is incident on the side surface 54C at an incident angle determined by the incident angle of the white light WL on the side surface 54A, the refractive index n, and the Snell's law, is refracted at the side surface 54C, and is emitted from the side surface 54C toward the +Z side along the Z axis like that in the second state.

In the third state, of the white light WL incident on the light-transmissive member 42 from the −Z side, the white light WL at the −Y side of the angle between the side surfaces 54A and 54B is refracted at the side surface 54B, is incident on the side surface 54D at an incident angle determined by the incident angle of the white light WL on the side surface 54B, the refractive index n, and the Snell's law, is refracted at the side surface 54D, and is emitted from the side surface 54D toward the +Z side along the Z axis. The separation distance d in the third state is larger than the separation distance d in the second state.

FIG. 4 is a schematic diagram of a fourth state in which the rotation of the light-transmissive member 42 further proceeds from the third state. As shown in FIG. 4, in the fourth state, the rotation angle @ is larger than 45° and smaller than 90°. In the fourth state, since the white light WL incident on the light-transmissive member 42 from the −Z side is incident at an incident angle equivalent to a narrow angle formed by a perpendicular line of the side surface 54B and the beam WBM, the white light is refracted at the side surface 54B to the +Y side with respect to the center axis JX according to the incident angle to the side surface 54B, the refractive index n, and the Snell's law.

In the fourth state, as described above, the white light WL incident on the inside of the light-transmissive member 42 is refracted at the side surface 54B, is incident on the side surface 54D at the incident angle determined by the incident angle of the white light WL on the side surface 54B, the refractive index n, and the Snell's law, is refracted at the side surface 54D, and is emitted from the side surface 54D toward the +Z side along the Z axis. The separation distance d in the fourth state is smaller than the separation distance d in the third state.

Although not illustrated, when the rotation state of the light-transmissive member 42 progresses, the side surface 54A of the light-transmissive member 42 is replaced with the side surface 54B, and the side surface 54B is replaced with the side surface 54C in the above-described behavior from the first state to the fourth state. Then, in the above-described behavior from the first state to the fourth state, the side surface 54A of the light-transmissive member 42 is replaced with the side surface 54C, and the side surface 54B is replaced with the side surface 54D. Then, in the above-described behavior from the first state to the fourth state, the side surface 54A of the light-transmissive member 42 is replaced with the side surface 54D, and the side surface 54B is replaced with the side surface 54A.

By the circulation of these behaviors, the white light WL emitted from the light-transmissive member 42 of the light scanning device 40 is scanned along the Y axis. The beam width on the X axis of the white light WL incident on the light-transmissive member 42 is larger than the beam width on the Y axis and is equivalent to the size on the X axis of the modulation surface 64 of the light modulation device 60, whereby the white light WL emitted from the light-transmissive member 42 is scanned on the XY plane. In the above-described behavior from the first state to the fourth state, the maximum value of the separation distance d is set to be equivalent to half the size of the modulation surface 64 on the Y axis. Based on this, the lengths and sizes of one side of the end surfaces 51, 52 of the light-transmissive member 42 and the refractive index n are appropriately set such that the maximum value of the separation distance d is equivalent to half the size of the modulation surface 64 on the Y axis.

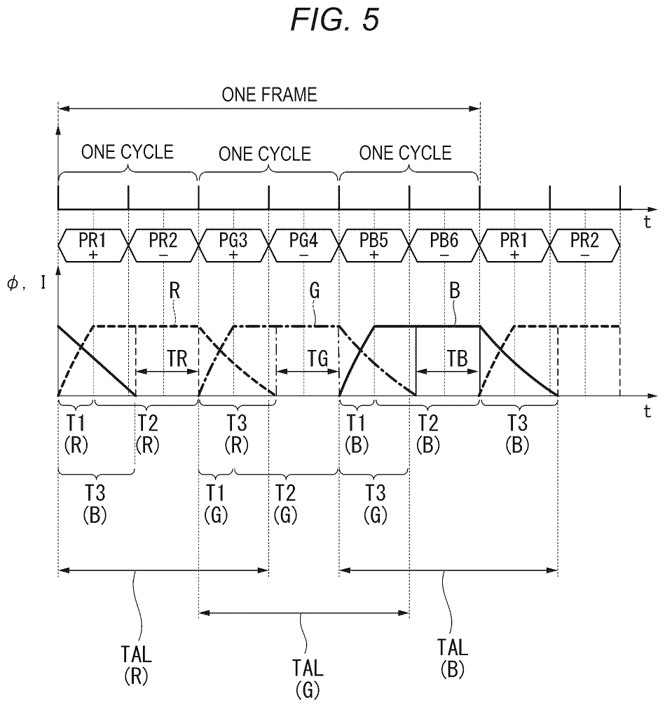

Next, the control of the control section 100 on the optical unit 10 of the projector 201 will be described. FIG. 5 is a time chart related to the operation of the light emitting element 21 of the light source device 20 and the liquid crystal panel 62 of the light modulation device 60.

In the following description, an input image to the liquid crystal panel 62 of the light modulation device 60 is divided into eight parts on the X axis orthogonal to the scanning direction of the white light WL. As seen along the Z axis from the −Z side, the input image to the liquid crystal panel 62 is divided into a first region X1, a second region X2, a third region X3, a fourth region X4, a fifth region X5, a sixth region X6, a seventh region X7, and an eighth region X8 from the −X side toward the +X side along the X axis.

In the input image to the liquid crystal panel 62, white is assigned to the first region X1 and displayed by a combination of a red light, a green light, and a blue light. Red is assigned to the second region X2 and displayed by a monochromatic light of only red light. Yellow is assigned to the third region X3 and displayed by a combination of a red light and a green light. Green is assigned to the fourth region X4 and displayed by a monochromatic light of only green light. Cyan is assigned to the fifth region X5 and displayed by a combination of a green light and a blue light. Blue is assigned to the sixth region X6 and displayed by a monochromatic light of only blue light. Magenta is assigned to the seventh region X7 and displayed by a combination of a red light and a blue light. Black is assigned to the eighth region X8 and does not contain any color light of a red light, a green light, and a blue light.

As illustrated in FIG. 5, in each pixel of the liquid crystal panel 62, a rising period T1 from the rising start time to the rising completion time, a constant period T2 from the rising completion time to the falling start time, and a falling period T3 from the falling start time to the falling completion time are generated for each of the red region R, the green region G, and the blue region B.

The rising period T1 corresponds to a first period, which will be described later. The constant period T2 corresponds to a second period, which will be described later. In the liquid crystal panel 62, the rising period T1 is, for example, about 1.5 ms, and the falling period T3 is, for example, about 3.0 ms.

In the time chart illustrated in FIG. 5, for example, it is assumed that red, green, and blue displayed frame by frame are switched by driving at 360 Hz. In this case, the frame rate is 180 fps, and the frame rate is 60 fps for color display. One cycle is about 2.78 ms.

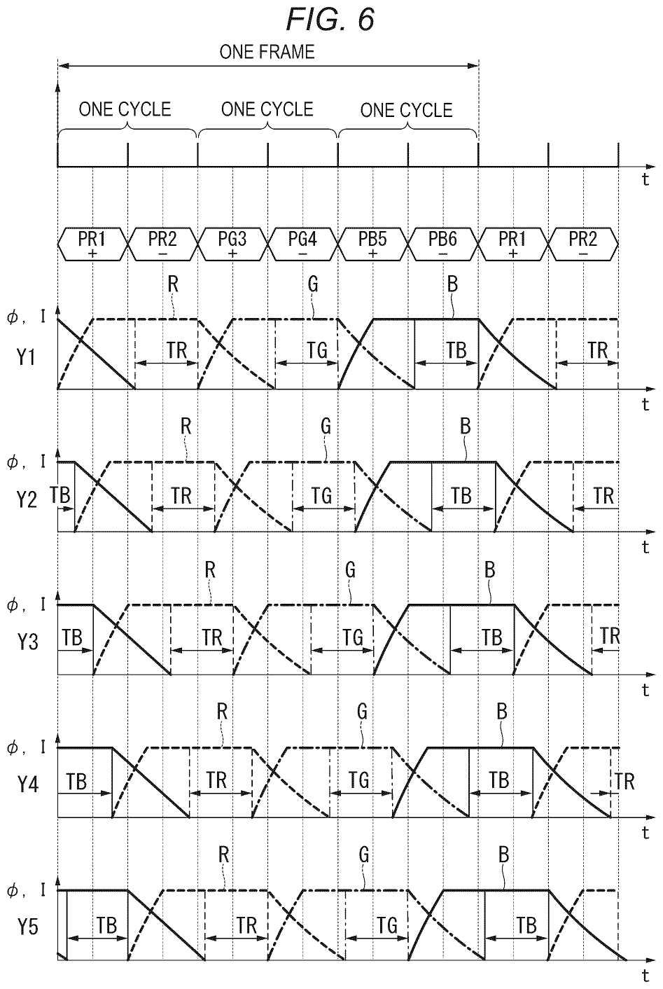

FIG. 6 is a time chart in which the horizontal axis indicates the time t as in FIG. 5, and the vertical axis indicates the response rate of the liquid crystal and the light intensity of the color light in each of regions when the modulation surface 64 in the liquid crystal panel 62 of the projector 201 according to the first embodiment is divided into five regions from a first region Y1 to a second region Y2, a third region Y3, a fourth region Y4, and a fifth region Y5 from the +Y side to the −Y side along the scanning direction, that is, the Y axis.

As shown in FIGS. 5 and 6, the modulation surface 64 is irradiated with the red light of the white light WL emitted from the light emitting element 21 of the light source device 20 through a color filter in a red irradiation period TR not overlapping the falling period T3 of the blue region B and the rising period T1 of the green region G in the constant period T2 of the red region R. The falling start time of the red region R and the rising start time of the green region G coincide with each other.

The modulation surface 64 is irradiated with the green light of the white light WL emitted from the light emitting element 21 through a color filter in a green irradiation period TG not overlapping the falling period T3 of the red region R and the rising period T1 of the blue region B in the constant period T2 of the green region G. The modulation surface 64 is irradiated with the blue light of the white light WL emitted from the light emitting element 21 through a color filter in a blue irradiation period TB that not overlapping the falling period T3 of the green region G and the rising period T1 of the red region R in the constant period T2 of the blue region B.

That is, in the projector 201, the modulation surface is irradiated with each color light only in the period in which the response of the liquid crystal of each pixel of the liquid crystal panel 62 is completed. Therefore, the color tone of the input video input from the control section 100 is accurately reproduced in the entire video projected on the projection surface such as a screen (not illustrated). In each of the red region R, the green region G, and the blue region B, the region is irradiated with the color light from the light emitting element 21 in all periods after the response of the liquid crystal is completed and not overlapping the rising periods and the falling periods of the other color regions.

A positive drive voltage PR1 and a negative drive voltage PR2 corresponding to the red light, a positive drive voltage PG3 and a negative drive voltage PG4 corresponding to the green light, and a positive drive voltage PB5 and a negative drive voltage PB6 corresponding to the blue light according to the frame rate are sequentially supplied to each pixel of the liquid crystal panel 62 of the light modulation device 60.

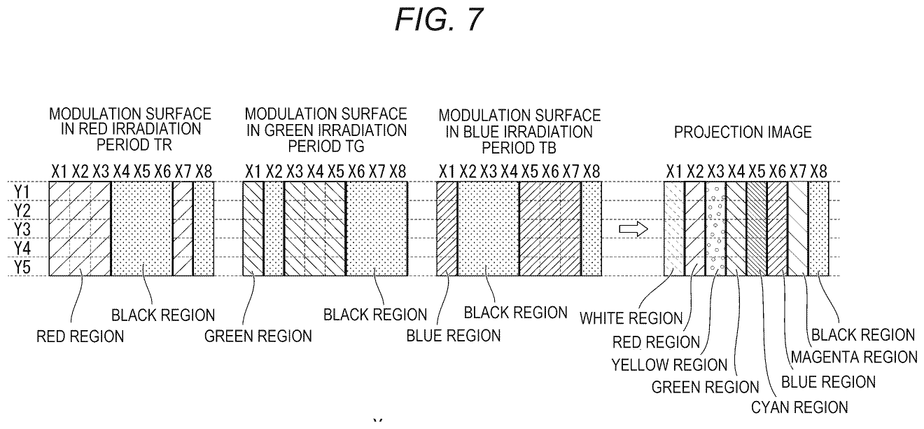

FIG. 7 schematic is a diagram showing distributions of the respective color regions in the modulation surface 64 divided into five regions. As shown in FIG. 7, in the projector 201 of the scanning illumination type controlled as shown in FIGS. 5 and 6, the intensity of the image light IL is improved as compared with the projector of the in-plane collective illumination in the related art. Under the above-described control, in any region of the modulation surface 64 and at the time t, the illuminance unevenness and the loss of the projection image on the projection surface are suppressed, and color mixture does not occur.

In the projector 201 of the scanning illumination type, the relative beam width on the Y axis of the white light WL scanned by the light scanning device 40 and emitted from the light scanning device 40 is larger, and each of the red irradiation period TR, the green irradiation period TG, and the blue irradiation period TB is secured to be longer as shown in FIGS. 5 to 7. When the constant intensity of the image light IL is obtained, the light density is suppressed, and the reliability of the projector 201 is higher. Since the relative beam width of the white light WL on the Y axis is larger, the irradiation efficiency of the white light WL is higher. In the case where each of the red irradiation period TR, the green irradiation period TG, and the blue irradiation period TB is secured to be longer as illustrated in FIGS. 5 to 7, it is necessary to take measures such that the color light does not separately appear from the start point when the scanning of the white light WL approaches the end point.

In the projector 201 of the scanning illumination type, when the relative beam width on the Y axis of the white light WL scanned by the light scanning device 40 and emitted from the light scanning device 40 is shortened, each of the red irradiation period TR, the green irradiation period TG, and the blue irradiation period TB is relatively shortened. When the constant intensity of the image light IL is obtained, the light density increases, and the reliability of the projector 201 is lower. Since the relative beam width of the white light WL on the Y axis is smaller, the irradiation efficiency of the white light WL is lower. The drive frequency of the liquid crystal of the liquid crystal panel 62 is increased, thereby exhibiting a tendency closer to the above described tendency.

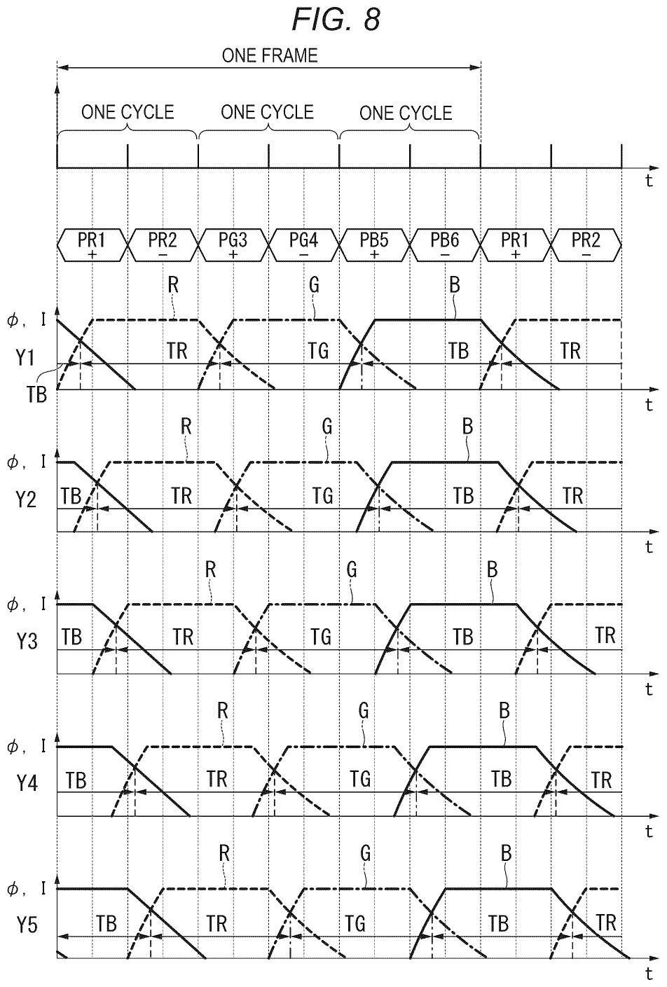

FIG. 8 is a time chart different from FIG. 6, in which the vertical axis indicates the response rate of the liquid crystal and the light intensity of the color light in each region when the modulation surface 64 in the liquid crystal panel 62 is divided into five regions along the scanning direction, that is, the Y axis at time t.

As illustrated in FIG. 8, the red irradiation period TR may be extended to a period between the intersection time of the falling edge of the blue region B and the rising edge of the red region R and the intersection time of the falling edge of the red region R and the rising edge of the green region G. Similarly, the green irradiation period TG may be extended to a period between the intersection time of the falling edge of the red region R and the rising edge of the green region G and the intersection time of the falling edge of the green region G and the rising edge of the blue region B. The blue irradiation period TB may be extended to a period between the intersection time of the falling edge of the green region G and the rising edge of the blue region B and the intersection time of the falling edge of the blue region B and the rising edge of the red region R.

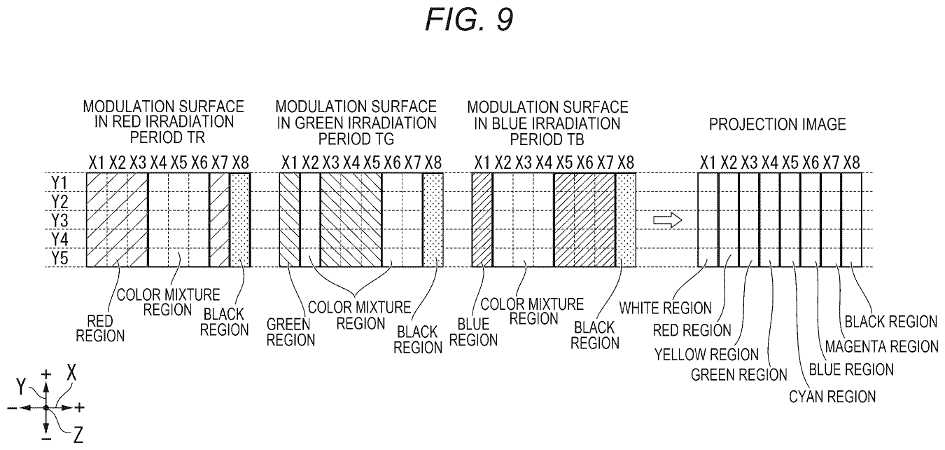

FIG. 9 is a schematic view different from FIG. 7, showing the distributions of the respective color regions on the modulation surface 64 divided into five regions. As shown in FIG. 9, in the red irradiation period TR in the control as shown in FIG. 8, the white color is increased in the red region R as compared with the control as shown in FIGS. 5 and 6. In the green region G and the blue region B, the red color is increased to be lighter as compared with the control as shown in FIGS. 5 and 6.

In the green irradiation period TG in the control as shown in FIG. 8, the white color is increased in the green region G as compared with the control as shown in FIGS. 5 and 6. In the blue region B and the red region R, the green color is increased to be lighter as compared with the control as shown in FIGS. 5 and 6. In the blue irradiation period TB in the control as shown in FIG. 8, the white color is increased in the blue region B as compared with the control as shown in FIGS. 5 and 6. In the red region R and the green region G, the blue color is increased to be lighter as compared with the control as shown in FIGS. 5 and 6.

In the projector 201 of the scanning illumination controlled as shown in FIG. 8, the intensity of the image light IL is improved as compared with the projector of the in-plane collective illumination in the related art. Under the above-described control, in any region of the modulation surface 64 and at the time t, the illuminance unevenness and the loss of the projection image on the projection surface are suppressed.

However, unlike the projector 201 of the scanning illumination type controlled as shown in FIG. 6, the color mixture uniformly occurs in any region of the modulation surface 64 and at the time t. Therefore, the triangular region of the chromaticity diagram that can be represented by the full-color image projected on the projection surface of the projector 201 of the scanning illumination type controlled as shown in FIG. 8 has vertexes closer to the center and is smaller as compared with the projector 201 of the scanning illumination type controlled as shown in FIG. 6.

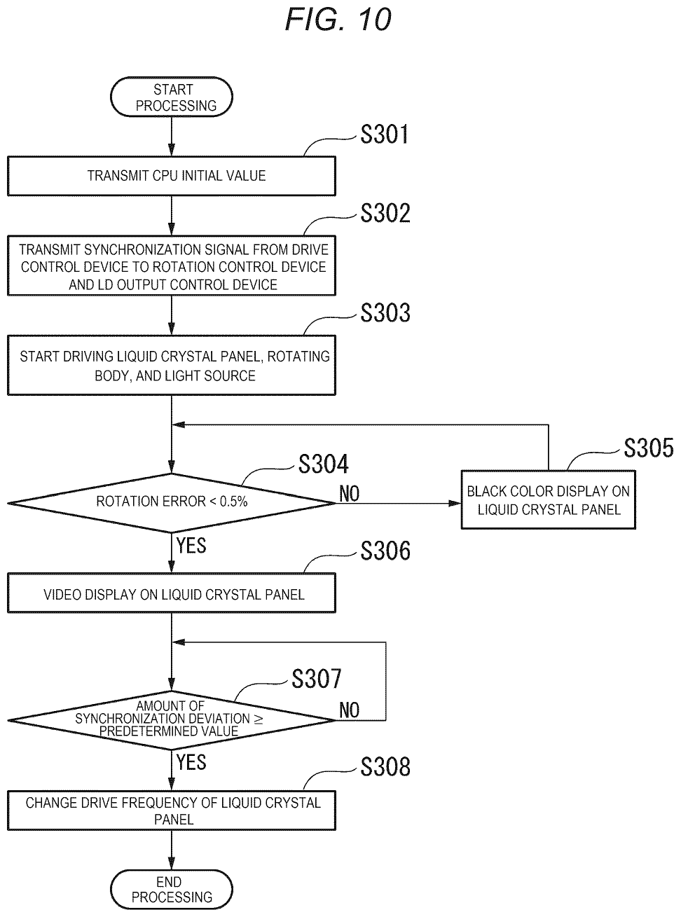

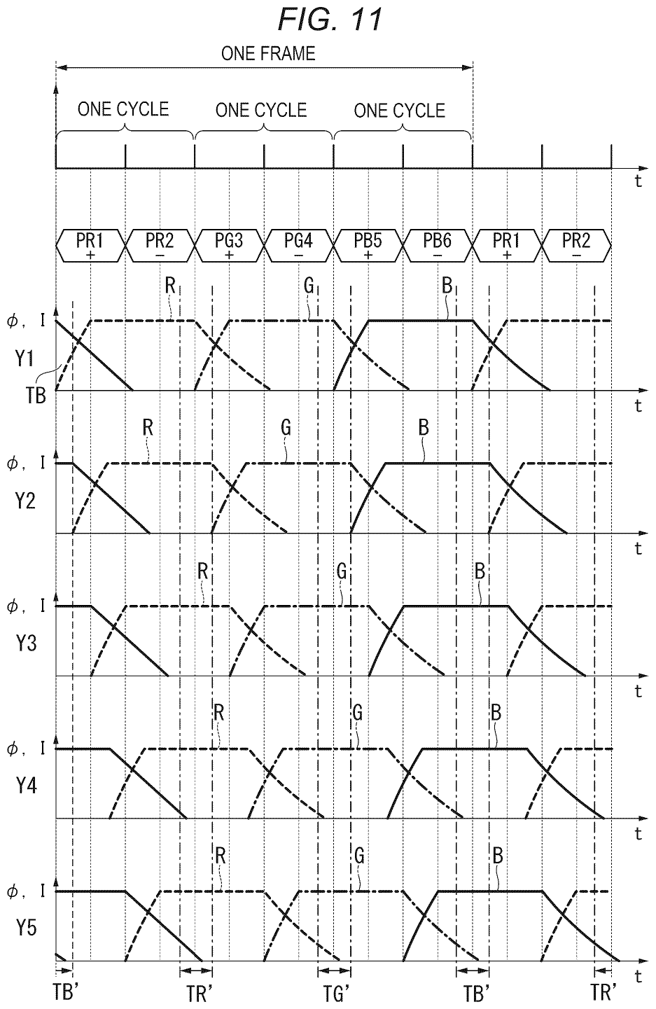

FIG. 10 is a flowchart related to control performed by the control section 100 as exemplified in FIGS. 5 to 9. As shown in FIG. 10, in step S301, the central processing unit 140 transmits various initial values to the drive control device 130 based on the video information received from the video processing circuit 160 and the refresh rate of the liquid crystal of the liquid crystal panel 62 set by the user interface 150 or the like. The various initial values include the video information to be projected, the drive frequency of the light emitting element 21, the drive frequency of the liquid crystal panel 62, the operation time, the standby period, thresholds for determining various malfunction differences, and the like.

In step S302, a synchronization signal is transmitted from the drive control device 130 to the light source output control device 110 and the rotation control device 120. In step S303, in response to the electrical signals from the light source output control device 110 and the rotation control device 120, the white light WL is cyclically emitted from the light emitting element 21 of the light source device 20, the light-transmissive member 42 of the light scanning device 40 rotates around the rotation axis CX, and the three color lights contained in the white light WL are converted into the image light IL by the liquid crystal of each pixel of the liquid crystal panel 62 of the light modulation device 60. Concurrently, errors indicating deviations of the amount and the output of the white light WL of the light emitting element 21 and the rotation speed of the light-transmissive member 42 from the set values are constantly detected and fed back to the drive control device 130.

In step S304, when the errors of the output of the light emitting element 21 and the rotation speed of the light-transmissive member 42 exceed a target error range of, for example, about 0.5%, in step S305, the black color is displayed in each pixel of the liquid crystal panel 62 until the errors fall within the target error range. When the errors of the output of the light emitting element 21 and the rotation speed of the light-transmissive member 42 fall within the target error range, in step S306, the color light is converted into the image light IL in each pixel of the liquid crystal panel 62.

In step S307, when the image light IL is generated in each pixel of the liquid crystal panel 62, an amount of synchronization deviation between the output cycle of the light emitting element 21 and the rotation speed of the light-transmissive member 42 is detected at a constant cycle, that is, at a constant time interval. While it is detected that the amount of synchronization deviation between the output cycle of the light emitting element 21 and the rotation speed of the light-transmissive member 42 is less than the predetermined value, each setting condition and each setting value are maintained.

When it is detected that the amount of synchronization deviation between the output cycle of the light emitting element 21 and the rotation speed of the light-transmissive member 42 is equal to or greater than a predetermined value, in step S308, the drive frequency of the liquid crystal panel 62 is changed to reduce the amount of synchronization deviation. As an example, when the drive frequency of the liquid crystal panel 62 on the Y axis is 1080/1124 lines, there is room for adjustment of about 97%. After the drive frequency of the liquid crystal panel 62 is changed in step S308, the process returns to step S306, and modulation and video display on the liquid crystal panel 62 based on the input image are performed under the changed conditions.

The projector 201 according to the first embodiment described above includes the light source device 20, the light scanning device 40, the light modulation device 60, and the projection optical system 80. The light source device 20 cyclically emits the white light (first light) WL. The light scanning device 40 cyclically scans the white light WL emitted from the light source device 20. The light modulation device 60 modulates the white light WL scanned by the light scanning device 40 and emitted from the light scanning device 40 according to the image information to generate the image light IL. The projection optical system 80 projects the image light IL emitted from the light modulation device 60 on the projection surface such as a screen. The light source device 20 has the light emitting element (first light emitting element) 21 that emits the white light WL. The light scanning device 40 includes the light-transmissive member (transmissive optical element) 42 having the side surfaces (incident surfaces) 54A, 54B, 54C, and 54D on which the white light WL emitted from the light source device 20 is incident and the side surfaces (emission surfaces) 54C, 54D, 54A, and 54B facing the side surfaces 54 described above, from which the white light WL is emitted. The light modulation device 60 includes the liquid crystal panel (liquid crystal element) 62 that converts the white light WL irradiating along a first direction parallel to the Y axis in accordance with the input image information into the image light IL to form an image along the first direction. The liquid crystal panel 62 has a liquid crystal layer in which the amount of phase modulation for each color light changes according to an input electrical signal. Specifically, in the liquid crystal layer, the refractive index of the liquid crystal with respect to each color light of the white light WL changes, and thus the amount of phase modulation with respect to each color light changes. In the projector 201 according to the first embodiment, a modulation period TAL in which the three color lights (first light) contained in the white light WL are modulated in the liquid crystal layer of the liquid crystal panel 62 includes the rising period (first period) T1 from the time when the electrical signal is input to the time when the amount of modulation of the liquid crystal layer changes to a predetermined value and the constant period (second period) T2 in which the amount of modulation of the liquid crystal layer is held at a predetermined value. In the projector 201 according to the first embodiment, the white light WL emitted from the light source device 20 is incident on the light modulation device 60 in the constant period T2.

In the projector 201 according to the first embodiment, in the scan illumination, the image formation cycle of the light modulation device 60, the scanning cycle of the white light WL from the light source device 20 by the light scanning device 40, and the light emission cycle of the light emitting element 21 of the light source device 20 are synchronized with one another. For example, when the light emitting element 21 is not cyclic like a lamp, but constantly turned on, in a specific pixel of the liquid crystal panel, the illumination light (first light) constantly irradiates from the start of the response, that is, the rising start time of the amount of modulation to the completion of the response, that is, the falling completion time of the amount of modulation. That is, since the illumination light is continuously incident until the liquid crystal is completely opened or closed, illuminance unevenness occurs on the projection surface such as a screen, and video quality or image quality is deteriorated. According to the projector 201 of the first embodiment, as described above, since the image formation cycle of the light modulation device 60, the scanning cycle of the white light WL from the light source device 20 by the light scanning device 40, and the light emission cycle of the light emitting element 21 of the light source device 20 are synchronized with one another, and the white light WL emitted from the light source device 20 is incident on the light modulation device 60 in the constant period T2, the occurrence of the illuminance unevenness of the projection image on the projection surface can be reliably suppressed.

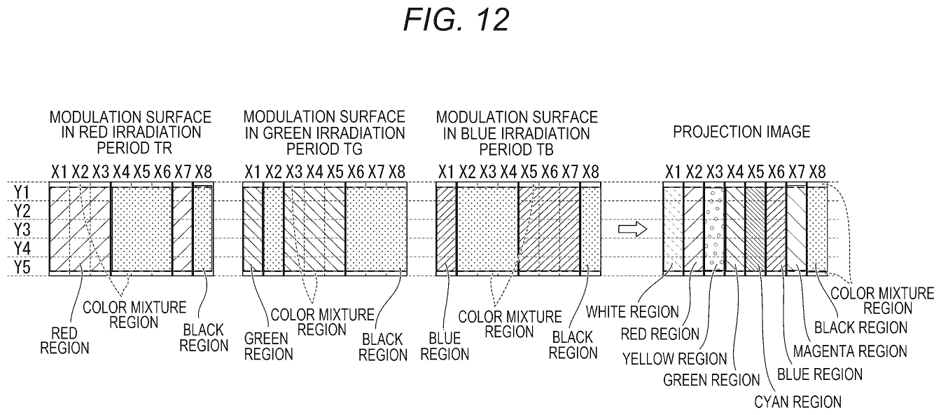

FIG. 11 corresponds to FIG. 6, and is a time chart in which the horizontal axis indicates time t, and the vertical axis indicates the response rate of the liquid crystal and the light intensity of the color light in each region when the modulation surface is divided into five regions along the scanning direction in the liquid crystal panel of the surface collective illumination projector in related art. FIG. 12 is a schematic diagram showing distributions of the respective color regions on the modulation surface divided into five regions of the liquid crystal panel of the surface collective illumination projector in related art.

As illustrated in FIGS. 11 and 12, in the case of the surface collective illumination, in the center portion of the Y axis of the modulation surface of the liquid crystal panel, that is, in the second region Y2 to the fourth region Y4 of the five regions, the rising period T1 and the falling period T3 of the liquid crystal corresponding to the color light of any color region do not overlap a red irradiation period TR′, a green irradiation period TG′, and a blue irradiation period TB′.

However, in the upper end portion of the modulation surface of the liquid crystal panel, i.e., the end portion at the +Y side, that is, in the first region Y1 of the five regions, the falling period T3 of the liquid crystal corresponding to the color light of the red region R and the rising period T1 of the liquid crystal corresponding to the color light of the green region G overlap the red irradiation period TR′. In the same end portion, the falling period T3 of the liquid crystal corresponding to the color light of the green region G and the rising period T1 of the liquid crystal corresponding to the color light of the blue region B overlap the green irradiation period TG′. The falling period T3 of the liquid crystal corresponding to the color light of the blue region B and the rising period T1 of the liquid crystal corresponding to the color light of the red region R overlap the blue irradiation period TB′. As a result, in the upper end portion of the modulation surface of the liquid crystal panel, that is, in the first region Y1 of the five regions, the color tone of the input video is not reproduced, and illuminance unevenness or color mixture of the projection image on the projection surface occurs.

In the lower end portion of the modulation surface of the liquid crystal panel, i.e., the end portion at the −Y side, that is, in the fifth region Y5 of the five regions, the falling period T3 of the liquid crystal corresponding to the color light of the blue region B overlaps the red irradiation period TR′. In the same end portion, the falling period T3 of the liquid crystal corresponding to the color light of the red region R overlaps the green irradiation period TG′. The falling period T3 of the liquid crystal corresponding to the color light of the green region G overlaps the blue irradiation period TB′. As a result, also in the lower end portion of the modulation surface of the liquid crystal panel, that is, in the fifth region Y5 of the five regions, the color tone of the input video is not reproduced, and illuminance unevenness or color mixture of the projection image occurs.

In the surface collective illumination projector in related art, the longer the red irradiation period TR′, the green irradiation period TG′, and the blue irradiation period TB′, the stronger the illuminance unevenness and the color mixture of the projection image. However, when the red irradiation period TR′, the green irradiation period TG′, and the blue irradiation period TB′ are shortened in order to suppress illuminance unevenness and color mixture of the projection image, the intensity of the image light IL decreases. According to the projector 201 of the first embodiment, as described above, the illuminance unevenness and the color mixture of the projection image can be suppressed and the intensity of the image light IL can be secured.

In the projector 201 according to the first embodiment, the light-transmissive member 42 of the light scanning device 40 has the end surfaces (first surfaces) 51, 52 parallel to the Y axis and the first direction and 2×m side surfaces (second surfaces) 54 in contact with the end surfaces 51, 52.

In the projector 201 according to the first embodiment, the light-transmissive member 42 has an even number of four or more of side surfaces 54, and all the side surfaces 54 face each other with the center axis JX in between and are parallel to each other. According to the projector 201 of the first embodiment, the white light WL emitted from the light source device 20 and incident on the light scanning device 40 can be emitted from the light scanning device 40 in the direction parallel to that at incidence.

The projector 201 according to the first embodiment further includes the drive control device 130 that transmits an electrical signal for driving the liquid crystal of the liquid crystal layer of each pixel to the liquid crystal panel 62 of the light modulation device 60. The drive control device 130 is electrically coupled to the light source output control device 110 that controls the output power and the output cycle of the white light WL emitted from the light emitting element 21 by outputting an electrical signal related to the drive voltage or the drive current to the light emitting element 21 of the light source device 20. The drive control device 130 is coupled to the light-transmissive member 42 of the light scanning device 40 via a motor or the like, and is coupled to the rotation control device 120 that controls the rotation speed of the light-transmissive member 42 around the rotation axis CX. The drive control device 130 transmits an electrical signal (synchronization signal) for synchronizing the output power of the white light WL from the light emitting element 21 and the rotation speed of the light-transmissive member 42 to the light source device 20 and the light scanning device 40 based on the electrical signal output to the liquid crystal panel 62.

The projector 201 according to the first embodiment includes the drive control device 130, and thus can easily synchronize the output power of the white light WL emitted from the light emitting element 21 with the rotation speed of the light-transmissive member 42.

In the projector 201 according to the first embodiment, when the error of the scanning cycle of the light scanning device 40 with respect to the image formation cycle of the liquid crystal panel 62 is equal to or greater than a predetermined value and the error of the light emission cycle of the light source device 20 with respect to the image formation cycle of the liquid crystal panel 62 is equal to or greater than a predetermined value, the light modulation device 60 does not emit the image light IL and displays the black color.

According to the projector 201 of the first embodiment, the display of an unexpected image not based on the image information or the video information input to the drive control device 130 can be suppressed.

In the projector 201 according to the first embodiment, the drive control device 130 changes the scanning cycle of the light scanning device 40 when the error of the scanning cycle of the light scanning device 40 with respect to the image formation cycle of the liquid crystal panel 62 of the light modulation device 60 is equal to or greater than a predetermined value. The scanning cycle of the light scanning device 40 is determined by the rotation speed of the light-transmissive member 42.

According to the projector 201 of the first embodiment, the synchronization state in which the light emission cycle of the light source device 20, the scanning cycle of the light scanning device 40, and the image formation cycle of the light modulation device 60 are synchronized with one another can be smoothly maintained, and the deterioration of the image quality over time can be suppressed.

In the projector 201 according to the first embodiment, when the error of the scanning cycle of the light scanning device 40 with respect to the image forming cycle of the liquid crystal panels 62 of the light modulation device 60 is equal to or greater than a predetermined value, the drive control device 130 changes the image forming cycle of the liquid crystal panels 62 of the light modulation device 60.

According to the projector 201 of the first embodiment, even when the control is performed as described above, the synchronization state in which the light emission cycle of the light source device 20, the scanning cycle of the light scanning device 40, and the image formation cycle of the light modulation device 60 are synchronized with one another can be smoothly maintained, and the deterioration of the image quality over time can be suppressed.

In the projector 201 according to the first embodiment, the modulation period TAL in which the three color lights (first light) contained in the white light WL are modulated in the liquid crystal layer of the liquid crystal panel 62 further includes the rising period T1 described above, the constant period T2, and the falling period T3 from the time when the amount of modulation of the liquid crystal layer is the predetermined value to the time when the amount of modulation completely returns to the initial value.

The rising period T1 represents a period from the rising start time to the rising completion time of the liquid crystal layer of the liquid crystal panel 62. The falling period T3 represents a period from the falling start time to the falling completion time of the liquid crystal layer of the liquid crystal panel 62. In the projector 201 according to the first embodiment, the white light WL emitted from the light source device 20 is not incident on the light modulation device 60 in the period of the constant period T2 in each color region of the liquid crystal panel 62 overlapping the falling period T3 of the other color region and the period of the constant period T2 overlapping the rising period T1 of the other color region.

In the projector 201 according to the first embodiment, the modulation period TAL in each pixel of the liquid crystal panel 62 of the light modulation device 60 includes the rising period (first period) T1, the constant period (second period) T2, and the falling period (third period) T3. The rising period T1 is a period from the time when the amount of phase modulation of the color light in the liquid crystal layer of the liquid crystal panel 62 changes from the initial value to a predetermined value and starts rising to the time when the amount of modulation reaches the predetermined value. The constant period T2 is a period in which the amount of phase modulation of the color light in the liquid crystal layer of the liquid crystal panel 62 is held constant at a predetermined value. The falling period T3 is a period from the time when the amount of phase modulation of the color light in the liquid crystal layer of the liquid crystal panel 62 changes from a predetermined value to the initial value and starts falling to the time when the amount of modulation reaches the initial value.

In the projector 201 according to the first embodiment, preferably, the white light WL emitted from the light source device 20 and operated in the first direction along the Y axis by the light scanning device 40 is incident on the liquid crystal panel 62 of the light modulation device 60 in the period not overlapping the rising period T1 or the falling period T3 of the green light (second color light) or the blue light (second color light) contained in the white light WL and having a wavelength band different from that of the red light in the constant period T2 of the red region R of the pixel with respect to the red light (first color light) contained in the white light WL. Similarly, the white light WL emitted from the light source device 20 is incident on the liquid crystal panel 62 in the period not overlapping the rising period T1 or the falling period T3 of the blue light (the second color light) or the red light (the second color light) contained in the white light WL and having a wavelength band different from that of the green light in the constant period T2 of the green region G of the pixel with respect to the green light (the first color light). The white light WL emitted from the light source device 20 is incident on the liquid crystal panel 62 in the period not overlapping the rising period T1 or the falling period T3 of the red light (second color light) or the green light (second color light) contained in the white light WL and having a wavelength band different from that of the blue light in the constant period T2 of the blue region B of the pixel with respect to the blue light (first color light).

That is, in the projector 201 according to the first embodiment, the control can be performed so that the white light WL is not incident on the pixel during the rising period T1 or the falling period T3 in which the liquid crystal molecules of the liquid crystal layer rotate with respect to the red light, the green light, or the blue light and the amount of phase modulation φ changes among the plurality of pixels of the liquid crystal panel 62. In other words, among the plurality of pixels of the liquid crystal panel 62, any one of the color lights of the red light, the green light, and the blue light is incident on a pixel during the constant period T2 of any one of the color lights described above in a period not overlapping the rising period T1 or the falling period T3 of the other color light. The liquid crystal layer functions as a color filter by increase or decrease of the amount of phase modulation φ added to the color light when transmitted through the liquid crystal of the liquid crystal layer of each pixel of the liquid crystal panel 62, and the light intensity I and the light amount of the color light transmitted through the liquid crystal layer increase or decrease. According to the projector 201 of the first embodiment controlled in this manner, the color tone of the input video is satisfactorily reproduced, and not only the illuminance unevenness of the projection image on the projection surface but also the color mixture of the color light for display and the color light not for display can be suppressed.

### Second Embodiment

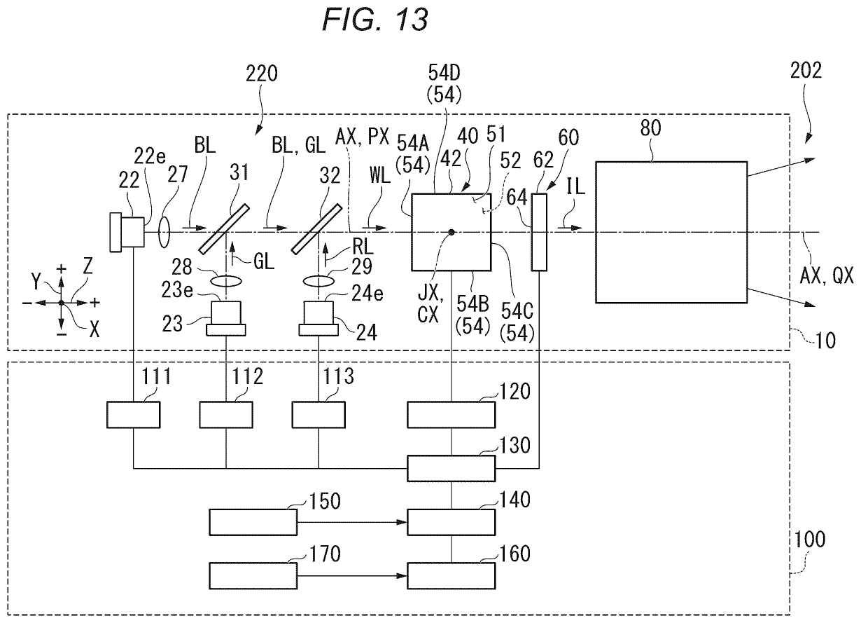

A second embodiment of the present disclosure will next be described with reference to FIG. 13. In the description of the second embodiment, the description of the contents in common with the first embodiment will be omitted, and only contents different from those in the first embodiment will be described. Further, regarding the configurations of a projector 202 according to the second embodiment, the configurations common to those of the projector 201 according to the first embodiment have the same signs as the corresponding configurations of the projector 201 according to the first embodiment, and the description thereof will be omitted.

FIG. 13 is a schematic diagram of the projector 202 according to the second embodiment of the present disclosure. As shown in FIG. 13, similarly to the projector 201, the projector 202 includes a light source device 220, the light scanning device 40, the light modulation device 60, the projection optical system 80, light source output control devices 111, 112, 113, the rotation control device 120, the drive control device 130, the central processing unit 140, the user interface 150, the video processing circuit 160, and the video interface 170.

The light source device 220 cyclically emits the white light WL. The light source device 220 includes a light emitting element 22 that emits a blue light BL, a light emitting element 23 that emits a green light GL, a light emitting element 24 that emits a red light RL, parallelizing lenses 27, 28, 29, and dichroic mirrors 31, 32.

The light emitting element 22 corresponds to the first light emitting element described in What is claimed is. The blue light BL corresponds to the first light to be described later. The light emitting element 22 emits the blue light BL from an emission surface 22e toward the +Z side along the Z axis. The light emitting element 22 is, for example, a blue LD or a blue LED.

The parallelizing lens 27 is disposed in the optical path of the blue light BL emitted from the light emitting element 22, is disposed at the same position as the emission surface 22e of the light emitting element 22 on the X axis and the Y axis, and is disposed at the +Z side of the emission surface 22e of the light emitting element 22. The center axis of the parallelizing lens 27 overlaps the optical axis of the blue light BL emitted from the light emitting element 22. The parallelizing lens 27 emits the blue light BL emitted from the light emitting element 22 along the optical axis AX as a parallel light parallel to the Z axis.

The parallelizing lens 27 is, for example, a biconvex lens. The parallelizing lens 27 may be a plano-convex lens having a flat incident surface parallel to the XY plane and an emission surface convex toward the +Z side. Although the parallelizing lens 27 is disposed apart from the emission surface 22e of the light emitting element 22 in FIG. 13, when the parallelizing lens 27 is a plano-convex lens, the parallelizing lens 27 may be in contact with the emission surface 22e of the light emitting element 22.

The light emitting element 23 corresponds to a second light emitting element, which will be described later. The green light GL corresponds to a second light, which will be described later. The light emitting element 23 is disposed at the same position as the light emitting element 22 on the X axis, is disposed at the −Y side of the light emitting element 22, is disposed at the +Z side of the light emitting element 22, and is disposed at the −Z side of the light-transmissive member 42 of the light scanning device 40. The light emitting element 23 emits the green light GL from an emission surface 23e toward the +Y side along the Y axis. The light emitting element 23 is, for example, a green LD or a green LED.

The parallelizing lens 28 is disposed in the optical path of the green light GL emitted from the light emitting element 23, is disposed at the same position as the emission surface 23e of the light emitting element 23 on the X axis and the Z axis, and is disposed between the emission surface 23e of the light emitting element 23 and the emission surface 22e of the light emitting element 22 on the Y axis. The center axis of the parallelizing lens 28 overlaps the optical axis of the green light GL emitted from the light emitting element 23 and intersects the center axis of the parallelizing lens 27. The parallelizing lens 28 emits the green light GL emitted from the light emitting element 23 toward the +Y side as a parallel light parallel to the Y axis.

The parallelizing lens 28 is, for example, a biconvex lens. The parallelizing lens 28 may be a plano-convex lens having a flat incident surface parallel to the XZ plane including the X axis and the Z axis and an emission surface convex toward the +Y side. Although the parallelizing lens 28 is disposed apart from the emission surface 23e of the light emitting element 23 in FIG. 13, when the parallelizing lens 28 is a plano-convex lens, the parallelizing lens 28 may be in contact with the emission surface 23e of the light emitting element 23.

The light emitting element 24 corresponds to the second light emitting element to be described later. The red light RL corresponds to the second light to be described later. The light emitting element 24 is disposed at the same position as the light emitting elements 22, 23 on the X axis, is disposed at the −Y side of the light emitting element 22, is disposed at the +Z side of the light emitting element 23, and is disposed at the −Z side of the light-transmissive member 42 of the light scanning device 40. The light emitting element 24 emits the red light RL from an emission surface 24e toward the +Y side along the Y axis. The light emitting element 24 is, for example, a red LD or a red LED.

The parallelizing lens 29 is disposed in the optical path of the red light RL emitted from the light emitting element 24, is disposed at the same position as the emission surface 24e of the light emitting element 24 on the X axis and the Z axis, and is disposed between the emission surface 24e of the light emitting element 24 and the emission surface 22e of the light emitting element 22 on the Y axis. The center axis of the parallelizing lens 29 overlaps the optical axis of the red light RL emitted from the light emitting element 24 and intersects the center axis of the parallelizing lens 27. The parallelizing lens 29 emits the red light RL emitted from the light emitting element 24 toward the +Y side as parallel light parallel to the Y axis.

The parallelizing lens 28 is, for example, a biconvex lens. The parallelizing lens 28 may be a plano-convex lens having a flat incident surface parallel to the XZ plane including the X axis and the Z axis and an emission surface convex toward the +Y side. Although the parallelizing lens 28 is disposed apart from the emission surface 23e of the light emitting element 23 in FIG. 13, when the parallelizing lens 28 is a plano-convex lens, the parallelizing lens 28 may be in contact with the emission surface 23e of the light emitting element 23.

The dichroic mirror 31 is disposed in a region where the optical path of the blue light BL emitted from the parallelizing lens 27 and the optical path of the green light GL emitted from the parallelizing lens 28 overlap each other. The center of the dichroic mirror 31 in the XY plane substantially overlaps the intersection of the optical axis of the blue light BL emitted from the light emitting element 22 and the optical axis of the green light GL emitted from the light emitting element 23.

The dichroic mirror 31 has a reflection surface that transmits the blue light BL and reflects the green light GL. The reflection surface of the dichroic mirror 31 is inclined from the −Z side and the −Y side to the +Z side and the +Y side as seen along the X axis. The blue light BL emitted from the parallelizing lens 27 is transmitted through the dichroic mirror 31 and is emitted toward the +Z side along the Z axis. The green light GL emitted from the parallelizing lens 28 is incident on the dichroic mirror 31, is reflected by the reflection surface of the dichroic mirror 31 toward the +Z side along the Z axis, and is superimposed on the blue light BL.

The dichroic mirror 32 is disposed in a region where the optical paths of the blue light BL and the green light GL emitted from the dichroic mirror 31 overlap the optical path of the red light RL emitted from the parallelizing lens 29. The center of the dichroic mirror 32 in the XY plane substantially overlaps the intersection of the optical axis of the blue light BL emitted from the light emitting element 22 and the optical axis of the red light RL emitted from the light emitting element 24.

The dichroic mirror 32 has a reflection surface that transmits the blue light BL and the green light GL and reflects the red light RL. The reflection surface of the dichroic mirror 32 is inclined from the −Z side and the −Y side to the +Z side and the +Y side as seen along the X axis. The blue light BL and the green light GL emitted from the dichroic mirror 31 are transmitted through the dichroic mirror 32 and then emitted toward the +Z side along the Z axis. The red light RL emitted from the parallelizing lens 29 enters the dichroic mirror 32, is reflected by the reflection surface of the dichroic mirror 32 toward the +Z side along the Z axis, and is superimposed on the blue light BL and the green light GL.

The blue light BL, the green light GL, and the red light RL emitted from the dichroic mirror 32 are combined as the white light WL, are emitted from the light source device 220 toward the +Z side along the optical axis AX, and incident on the light-transmissive member 42 of the light scanning device 40 as the white light WL. The behavior of the white light WL emitted from the light source device 220 in the projector 202 is similar to the behavior of the white light WL emitted from the light source device 20 in the projector 201.

The light source device 220, the light scanning device 40, the light modulation device 60, and the projection optical system 80 described above form the optical unit 10 of the projector 202.

The light source output control device 111 is electrically coupled to the light emitting element 22 of the light source device 220 in a wired or wireless manner, and controls the amount of blue light BL emitted from the light emitting element 22. Specifically, the light source output control device 111 outputs an electrical signal related to a drive voltage or a drive current for controlling the amount of the blue light BL emitted from the light emitting element 22 to the light emitting element 22, and causes the blue light BL to be cyclically emitted from the light emitting element 22. The light source output control device 111 is, for example, an LD driver or an LED driver. The driver as the light source output control device 111 stores and saves a program of a cyclic drive voltage value or drive current value for the light emitting element 22 corresponding to the elapsed time and the time t.

The light source output control device 112 is electrically coupled to the light emitting element 23 of the light source device 220 in a wired or wireless manner, and controls the amount of green light GL emitted from the light emitting element 23. Specifically, the light source output control device 112 outputs an electrical signal related to a drive voltage or a drive current for controlling the amount of the green light GL emitted from the light emitting element 23 to the light emitting element 23, and cyclically emits the green light GL from the light emitting element 23. The light source output control device 112 is, for example, an LD driver or an LED driver. The driver as the light source output control device 112 stores and saves a program of a cyclic drive voltage value or drive current value for the light emitting element 23 corresponding to the elapsed time and the time t.

The light source output control device 113 is electrically coupled to the light emitting element 24 of the light source device 220 in a wired or wireless manner, and controls the amount of the red light RL emitted from the light emitting element 24. Specifically, the light source output control device 113 outputs an electrical signal related to a drive voltage or a drive current for controlling the light amount of the red light RL emitted from the light emitting element 24 to the light emitting element 24, and causes the red light RL to be cyclically emitted from the light emitting element 24. The light source output control device 113 is, for example, an LD driver or an LED driver. The driver as the light source output control device 113 stores and saves a program of a cyclic drive voltage value or drive current value for the light emitting element 24 corresponding to the elapsed time and the time t.

The drive control device 130 is electrically coupled to the light source output control devices 111, 112, 113 and the rotation control device 120, and is electrically coupled to the liquid crystal panel 62 of the light modulation device 60 in a wired or wireless manner. The drive control device 130 outputs an electrical signal to each of the light source output control devices 111, 112, 113 and the rotation control device 120, and controls the position, the region, and the timing on the XY plane at which the blue light BL emitted from the light emitting element 22 of the light source device 220, the green light GL emitted from the light emitting element 23, and the red light RL emitted from the light emitting element 24 are scanned by the light-transmissive member 42 of the light scanning device 40 as the white light WL and are irradiated on the modulation surface 64 of the liquid crystal panel 62 of the light modulation device 60. The drive control device 130 supplies an electrical signal to each pixel of the liquid crystal panel 62 on the modulation surface 64 in accordance with the irradiation position, the irradiated region, and the timing of the white light WL described above.

The light source output control devices 111, 112, 113, the rotation control device 120, the drive control device 130, the central processing unit 140, the user interface 150, the video processing circuit 160, and the video interface 170 described above form the control section 100 of the projector 202. The control performed by the control section 100 of the projector 202 on the optical unit 10 is the same as the control performed by the control section 100 of the projector 201 on the optical unit 10.

In the control in the projector 202, in step S301 of the flowchart referred to in FIG. 10, the central processing unit 140 transmits various initial values to the drive control device 130 based on the video information received from the video processing circuit 160 and the refresh rate of the liquid crystal of the liquid crystal panel 62 set by the user interface 150 or the like. The various initial values include the video information to be projected, the drive frequencies of the light emitting elements 22, 23, 24, the drive frequency of the liquid crystal panel 62, the operation time, the standby period, thresholds for determining various malfunction differences, and the like.

In step S303, in response to the electrical signals from the light source output control device 110 and the rotation control device 120, the blue light BL is cyclically emitted from the light emitting element 22 of the light t source device 220, the green light GL is cyclically emitted from the light emitting element 23, and the red light RL is cyclically emitted from the light emitting t 24, and thus the white light WL is cyclically emitted from the light source device 220.

In step S304, when the errors of the output of the light source device 220 depending on the output of the light emitting elements 22, 23, 24 and the rotation speed of the light-transmissive member 42 exceed a target error range of, for example, about 0.5%, in step S305, the black color is displayed in each pixel of the liquid crystal panel 62 until the errors fall within the target error range. When the errors of the output of the light source device 220 and the rotation speed of the light-transmissive member 42 fall within the target error range, in step S306, the color light is converted into the image light IL in each pixel of the liquid crystal panel 62.

In step S307, when the image light IL is generated in each pixel of the liquid crystal panel 62, an amount of synchronization deviation between the output cycle of the light emitting element 21 and the rotation speed of the light-transmissive member 42 is detected at a constant cycle, that is, at a constant time interval. While it is detected that the amount of synchronization deviation between the output cycle of the light emitting element 21 and the rotation speed of the light-transmissive member 42 is less than the predetermined value, each setting condition and each setting value are maintained. When it is detected that the amount of synchronization deviation between the output cycle of the light emitting element 21 and the rotation speed of the light-transmissive member 42 is equal to or greater than a predetermined value, in step S308, the drive frequency of the liquid crystal panel 62 is changed to reduce the amount of synchronization deviation.

The projector 202 according to the second embodiment described above includes the light source device 220, the light scanning device 40, the light modulation device 60, and the projection optical system 80. The light source device 220 cyclically emits the white light (first light) WL. The light scanning device 40 cyclically scans the white light WL emitted from the light source device 220. The light source device 220 includes the light emitting element (first light emitting element) 22 that emits the blue light BL contained in the white light WL, the light emitting element 23 that emits the green light GL contained in the white light WL, and the light emitting element 24 that emits the red light RL contained in the white light WL. In the projector 202 according to the second embodiment, the modulation period TAL in which the three color lights contained in the white light WL are modulated in the liquid crystal layer of the liquid crystal panel 62 includes the rising period (first period) T1 from the time when the electrical signal is input to the time when the amount of modulation of the liquid crystal layer changes to the predetermined value, and the constant period (second period) T2 in which the amount of modulation of the liquid crystal layer is held at a predetermined value. Also in the projector 202 according to the second embodiment, the white light WL emitted from the light source device 220 is incident on the light modulation device 60 in the constant period T2.

In the projector 202 according to the second embodiment, similarly to the projector 201 according to the first embodiment, the image formation cycle of the light modulation device 60, the scanning cycle of the white light WL from the light source device 220 by the light scanning device 40, and the light emission cycles of the light emitting elements 22, 23, 24 of the light source device 220 are synchronized in the scan illumination. According to the projector 202 of the second embodiment, since the image formation cycle of the light modulation device 60, the scanning cycle of the white light WL from the light source device 220 by the light scanning device 40, and the light emission cycles of the light emitting elements 22, 23, 24 of the light source device 220 are synchronized with one another, and the white light WL emitted from the light source device 220 is incident on the light modulation device 60 in the constant period T2, the occurrence of the illuminance unevenness of the projection image on the projection surface can be reliably suppressed.

In the projector 202 according to the second embodiment, similarly to the projector 201 according to the first embodiment, the control can be performed so that the white light WL is not incident on the pixel during the rising period T1 or the falling period T3 in which the liquid crystal molecules of the liquid crystal layer rotate with respect to the red light, the green light, or the blue light and the amount of phase modulation @ changes among the plurality of pixels of the liquid crystal panel 62 of the light modulation device 60. That is, among the plurality of pixels of the liquid crystal panel 62, any one of the color lights of the red light, the green light, and the blue light is incident on a pixel during the constant period T2 of any one of the color lights described above in a period not overlapping the rising period T1 or the falling period T3 of the other color light. According to the projector 202 of the second embodiment, the color tone of the input video is satisfactorily reproduced, and not only the illuminance unevenness of the projection image but also the color mixture of the color light for display and the color light not for display can be suppressed.

In the projector 202 according to the second embodiment, the light source device 220 includes the light emitting element (first light source) 22 that emits the blue light (first light) BL, and further includes the light emitting element (second light source) that emits the green light (second light) GL and the light emitting element (second light source) that emits the red light (second light) RL. The blue light BL, the green light GL, and the red light RL emitted from the light source device 220 are operated by the light scanning device 40 and collectively incident on the light modulation device 60. In each pixel of the liquid crystal panel 62 of the light modulation device 60, the red light RL is incident on the red region R, the green light GL is incident on the green region G, and the blue light BL is incident on the blue region B by a color filter or the like. Since the red light RL, the green light GL, and the blue light BL are controlled to be incident on the liquid crystal layers in the respective color regions in accordance with the fixed time T2 in different periods, the red light RL, the green light GL, and the blue light BL are incident on the light modulation device 60 in different periods.

The projector 202 according to the second embodiment individually includes the light emitting element 22 that emits red light RL, the light source output control device 111 coupled to the light emitting element 22, the light emitting element 23 that emits the green light GL, the light source output control device 112 coupled to the light emitting element 23, the light emitting element 24 that emits the blue light BL, and the light source output control device 113 coupled to the light emitting element 24. According to the projector 202 of the second embodiment, since the red light RL is incident on each pixel of the liquid crystal panel 62 of the light modulation device 60 in accordance with the red irradiation period TR, the green light GL is incident on each pixel in accordance with the green irradiation period TG, and the blue light BL is incident on each pixel in accordance with the blue irradiation period TB, the quality and the color reproducibility of the projection image can be enhanced.

Preferable embodiments of the present disclosure have been described above in detail. The present disclosure is, however, not limited to the specific embodiments, and various modifications and changes can be made within the scope of the gist of the present disclosure described in What is claimed is. The Component elements of the plurality of embodiments can be combined as appropriate.

For example, in the embodiments described above, the projector that projects a multicolor, that is, full-color projection image that can be displayed with the white light including the red light, the green light, and the blue light is presented. However, the configurations of the projector according to the embodiments described above may be applied to a projector that projects a monochromatic projection image. Also in the monochromatic projector, the configurations described in the embodiments described above are provided, thereby synchronizing the light emission cycle of the first light from the light emitting element of the light source device, the scanning cycle of the monochromatic first light emitted from the light source device by the light scanning device, and the image formation cycle of the light modulation device with one another and irradiating the liquid crystal layer of the pixel is irradiated with the first light in a constant period in which the modulation factor with respect to the color light of the liquid crystal layer of the pixel of the liquid crystal element is held constant at a predetermined value. Therefore, the occurrence of the illuminance unevenness of the projection image on the projection surface can be reliably suppressed.

### Summary of Present Disclosure

The present disclosure will be summarized below as Appendices.

(Appendix 1) A projector includes a light source device that cyclically emits a first light, a light scanning device that cyclically scans the first light emitted from the light source device, a light modulation device that modulates the first light emitted from the light scanning device according to image information, and a projection optical system that projects an image light emitted from the light modulation device, wherein the light source device includes a first light emitting element that emits the first light, the light scanning device includes a transmissive optical element having an incident surface on which the first light emitted from the light source device is incident and an emission surface from which the first light incident from the incident surface is emitted, the light modulation device includes a liquid crystal element that forms an image by converting the first light emitted along a first direction according to the input image information into an image light, a direction in which the light scanning device scans the first light is the first direction, the light scanning device scans the first light in synchronization with a drive cycle of the light source device and an image formation cycle of the light modulation device, the liquid crystal element includes a liquid crystal layer in which an amount of modulation for the first light changes according to an input electrical signal, a modulation period in which the first light is modulated in the liquid crystal layer includes a first period from a time when an electrical signal is input to a time when an amount of modulation reaches a predetermined value and a second period in which the amount of modulation is held at the predetermined value, and the first light emitted from the light source device is incident on the light modulation device in the second period.

According to the configuration of Appendix 1, since the color light to be modulated is incident in the second period in which the response and the amount of phase modulation of the liquid crystal are held at the predetermined values in part of a plurality of pixels of the liquid crystal element of the light modulation device, the color reproducibility of the projection image for an input image is enhanced, and the occurrence of the illuminance unevenness of the projection image can be suppressed.

(Appendix 2) In the projector according to Appendix 1, the transmissive optical element has a first surface parallel to the first direction and 2×m second surfaces in contact with the first surface. The m is a natural number of 2 or more.

According to the configuration of Appendix 2, the first light scanned by the light scanning device and emitted from the light scanning device can be emitted parallel to the principal ray of the first light incident on the light scanning device.

(Appendix 3) In the projector according to Appendix 1 or 2, the light source device further includes a second light source that emits a second light, and the first light and the second light are incident on the light modulation device in different periods from each other.

According to the configuration of Appendix 3, for example, since the first light and the second light having a wavelength band different from that of the first light are incident on a pixel of the liquid crystal element of one light modulation device of a single-LCD projector in an irradiation period and a cycle corresponding to each color light, the quality of the projection image can be improved.

(Appendix 4) The projector according to any one of Appendices 1 to 3, further includes a drive control device that transmits the electrical signal to the light modulation device, wherein the drive control device transmits a synchronization signal based on the electrical signal to the light source device and the light scanning device.

According to the configuration of Appendix 4, the power, the cycle, and the timing of the first light emitted from the light source device can be easily synchronized with the scanning cycle of the light modulation device that scans the modulation surface of the light modulation device with the first light emitted from the light source device.

(Appendix 5) In the projector according to any one of Appendices 1 to 4, the light modulation device does not emit an image light when an error of a scanning cycle of the light scanning device with respect to an image formation cycle of the light modulation device is equal to or greater than a predetermined value and an error of a light emission cycle of the light source device with respect to the image formation cycle of the light modulation device is equal to or greater than a predetermined value.

According to the configuration of Appendix 5, the projection and display of an unexpected image or video not based on the image information or video information transmitted from a user interface or the like on the projection surface can be suppressed.

(Appendix 6) In the projector according to Appendix 4, the drive control device changes a scanning cycle of the light scanning device when an error of the scanning cycle of the light scanning device with respect to an image formation cycle of the light modulation device is equal to or greater than a predetermined value.

According to the configuration of Appendix 6, the degree of association among the power, the light emission cycle, and the timing of the first light emitted from the light source device, the scanning cycle of the light modulation device that scans the modulation surface of the light modulation device with the first light emitted from the light source device, and the fluctuation cycle of the amount of modulation with respect to the color light and the image formation cycle in each pixel of the liquid crystal element of the light modulation device can be adjusted, the cycles and the timing described above can be synchronized, and the display of an image not based on the image information input to the light modulation device can be suppressed.

(Appendix 7) In the projector according to Appendix 4, the drive control device changes an image formation cycle of the light modulation device when an error of a scanning cycle of the light scanning device with respect to the image formation cycle of the light modulation device is equal to or greater than a predetermined value.

According to the configuration of Appendix 7, the degree of association among the power, the light emission cycle, and the timing of the first light emitted from the light source device, the scanning cycle of the light modulation device that scans the modulation surface of the light modulation device with the first light emitted from the light source device, and the fluctuation cycle of the amount of modulation with respect to the color light and the image formation cycle in each pixel of the liquid crystal element of the light modulation device can be adjusted, the cycles and the timing described above can be synchronized, and the display of an image not based on the image information input to the light modulation device can be suppressed.

(Appendix 8) In the projector according to any one of Appendices 1 to 7, the modulation period further includes a third period from a time when the amount of modulation of the liquid crystal layer is the predetermined value to a time when the amount of modulation reaches an initial value, and the first light emitted from the light source device is incident on the light modulation device in a period that does not overlap the first period or the third period for a second color light having a wavelength band different from that of a first color light contained in the first light in the second period for the first color light contained in the first light.

According to the configuration of Appendix 8, since the rising period, that is, the first period, and the falling period, that is, the third period, for the second color light do not overlap the modulation period, that is, the second period, for the first color light in a liquid crystal panel of the light modulation device, not only the illuminance unevenness in the projection image but also the occurrence of color mixture can be reliably suppressed.

What is claimed is:

1. A projector comprising:
a light source device that cyclically emits a first light;
a light scanning device that cyclically scans the first light emitted from the light source device;
a light modulation device that modulates the first light emitted from the light scanning device according to image information; and
a projection optical system that projects an image light emitted from the light modulation device, wherein
the light source device includes a first light emitting element that emits the first light,
the light scanning device includes a transmissive optical element having an incident surface on which the first light emitted from the light source device is incident and an emission surface from which the first light incident from the incident surface is emitted,
the light modulation device includes a liquid crystal element that forms an image by converting the first light emitted along a first direction according to the input image information into an image light,
a direction in which the light scanning device scans the first light is the first direction,
the light scanning device scans the first light in synchronization with a drive cycle of the light source device and an image formation cycle of the light modulation device,
the liquid crystal element includes a liquid crystal layer in which an amount of modulation for the first light changes according to an input electrical signal,
a modulation period in which the first light is modulated in the liquid crystal layer includes a first period from a time when an electrical signal is input to a time when an amount of modulation reaches a predetermined value and a second period in which the amount of modulation is held at the predetermined value, and
the first light emitted from the light source device is incident on the light modulation device in the second period.

2. The projector according to claim 1, wherein
the transmissive optical element has a first surface parallel to the first direction and 2×m second surfaces in contact with the first surface,
m being a natural number of 2 or more.

3. The projector according to claim 1, wherein
the light source device further includes a second light source that emits a second light, and
the first light and the second light are incident on the light modulation device in different periods from each other.

4. The projector according to claim 1, further comprising a drive control device that transmits the electrical signal to the light modulation device, wherein
the drive control device transmits a synchronization signal based on the electrical signal to the light source device and the light scanning device.

5. The projector according to claim 1, wherein
the light modulation device does not emit an image light when an error of a scanning cycle of the light scanning device with respect to an image formation cycle of the light modulation device is equal to or greater than a predetermined value and an error of a light emission cycle of the light source device with respect to the image formation cycle of the light modulation device is equal to or greater than a predetermined value.

6. The projector according to claim 4, wherein
the drive control device changes a scanning cycle of the light scanning device when an error of the scanning cycle of the light scanning device with respect to an image formation cycle of the light modulation device is equal to or greater than a predetermined value.

7. The projector according to claim 4, wherein
the drive control device changes an image formation cycle of the light modulation device when an error of a scanning cycle of the light scanning device with respect to the image formation cycle of the light modulation device is equal to or greater than a predetermined value.

8. The projector according to claim 1, wherein
the modulation period further includes a third period from a time when the amount of modulation is the predetermined value to a time when the amount of modulation reaches an initial value, and
the first light emitted from the light source device is incident on the light modulation device in a period that does not overlap the first period or the third period for a second color light having a wavelength band different from that of a first color light contained in the first light in the second period for the first color light contained in the first light.
